(19) United States
(12) Patent Application Publication
(10) Pub. No.: US 2008/0083717 A1
(43) Pub. Date: Apr. 10, 2008

(54) Heatable utensil device and system

(76) Inventors: Michele Degrace, Wayne, NJ (US); Bruce Peter Popek, South Windsor, CT (US); Damian Mucaro, Hackensack, NJ (US); Carrie Burns, Wayne, NJ (US)

Correspondence Address: FAY KAPLUN & MARCIN, LLP, 15O BROADWAY, SUITE 702, NEW YORK, NY, 10038, US

(21) Appl. No.: 11/524,005

(22) Filed: Sep. 19, 2006

(51) Int. Cl. H05B 3/00

(52) U.S. Cl. 219/201

(57) ABSTRACT

Described is a heatable utensil and system. A device comprises a utensil attachment and a handle. The utensil attachment includes a housing, a first connector and a heating element. The housing at least partially situates the heating element. The handle includes a handheld housing, a second connector and a power source. The handheld housing at least partially situates the power source. The utensil attachment and the handle are detachably coupled using the first and second connectors. When the first and second connectors are coupled together, the heating element draws power from the power source to increase a temperature of at least a portion of the housing of the utensil attachment.

### PRIORITY CLAIM

The present application claims priority to U.S. Provisional Patent Application Ser. No. 60/808,498 entitled “Ice Cream Center” filed May 26, 2006, the entire disclosure of which is incorporated herein by reference.

### BACKGROUND

Food items stored in a freezer typically must be defrosted before being served or cooked. For example, ice cream and ice cream cakes must be removed from the freezer and allowed to defrost before they can be scooped or cut. Scooping the ice cream immediately after its removal from the freezer is very difficult, because a great deal of force is required to extract portions from a container. However, while the ice cream remains outside of the freezer for too long, it may begin to melt, making it difficult to serve and ruining any aesthetic/decorative element. Thus, there is a need for a device which allows frozen food items to be cut, scooped, etc. while they are frozen (e.g., immediately upon removal from the freezer).

### SUMMARY OF THE INVENTION

The present invention relates to a heatable utensil device and system. The device comprises a utensil attachment and a handle. The utensil attachment includes a housing, a first connector and a heating element. The housing at least partially situates the heating element. The handle includes a handheld housing, a second connector and a power source. The handheld housing at least partially situates the power source. The utensil attachment and the handle are detachably coupled using the first and second connectors. When the first and second connectors are coupled together, the heating element draws power from the power source to increase a temperature of at least a portion of the housing of the utensil attachment.

### BRIEF DESCRIPTION OF THE DRAWINGS

FIG. 1 shows an exemplary embodiment of a system according to the present invention.

FIG. 2 shows an exemplary embodiment of a base according to the present invention.

FIG. 3 shows an exemplary embodiment of a heatable utensil according to the present invention.

FIG. 4 shows an exemplary embodiment of a utensil attachment for a heatable utensil according to the present invention.

FIG. 5 shows another exemplary embodiment of a utensil attachment for a heatable utensil according to the present invention.

### DETAILED DESCRIPTION

The present invention may be further understood with reference to the following description and the appended drawings, wherein like elements are provided with the same reference numerals. The exemplary embodiments will described with reference to a utensil device which may be heated to scoop, cut, etc. a frozen food item. However, those of skill in the art will understand that, in other exemplary embodiments, the utensil may be utilized on non-food items (e.g., wax, plastics, etc.).

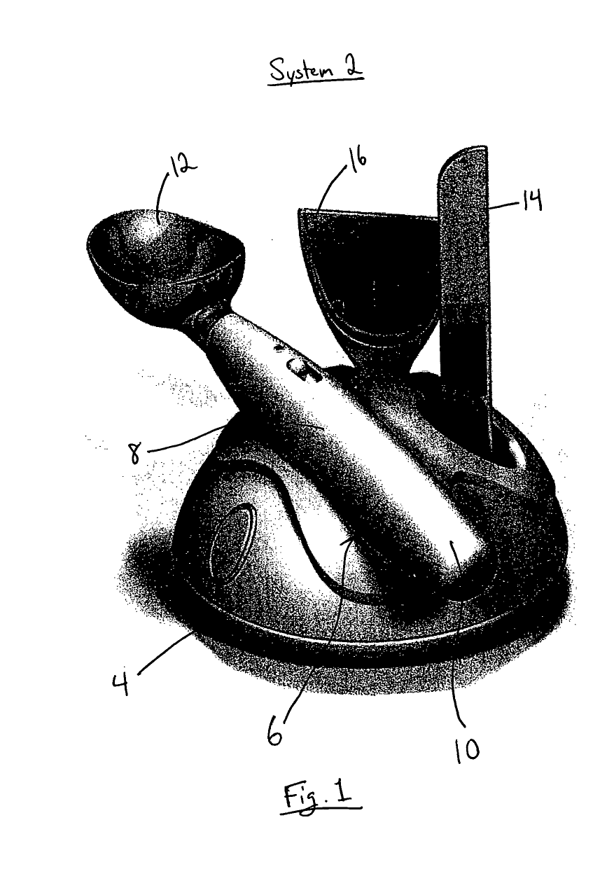

FIG. 1 shows an exemplary embodiment of a system 2 according to the present invention. The system 2 includes a base 4 which utilizes a receiving arrangement 6 to detachably receive a utensil 8. In the exemplary embodiment, the utensil 8 comprises a handle 10 which interchangeably receives a plurality of utensil attachments such as, for example, an ice cream scoop 12, a knife 14, a server 16, a spoon, a fork, a melon baler, a cookie cutter, etc. The base 4 may include one or more connectors for detachably receiving each of the utensil attachments. Thus, when the utensil 8 is being used with the scoop 12, the knife 14 and the server 16 may be coupled to the base 4 to reduce the likelihood of loss or damage.

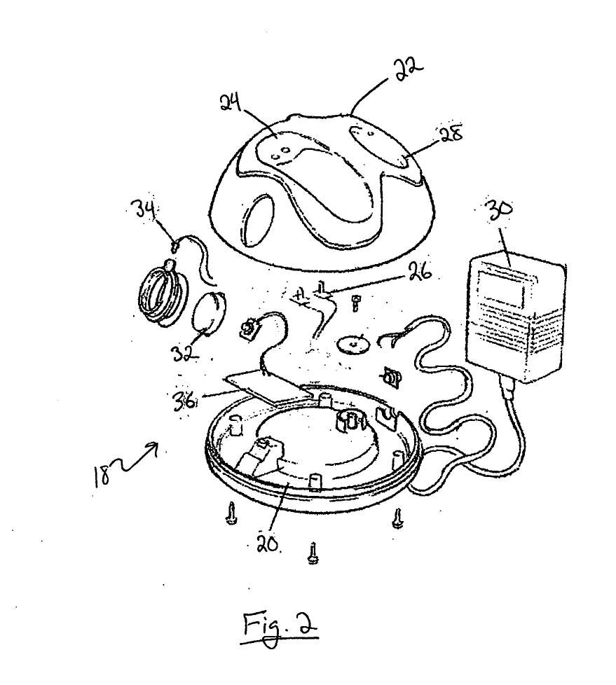

FIG. 2 shows a detailed view of an exemplary embodiment of the base 4 according to the present invention. In the exemplary embodiment, the base 4 may be formed from a dome-shaped housing 18 so that the base 4 has a low-profile when disposed on a substantially horizontal surface (e.g., table, counter top, etc.). Those of skill in the art will understand that the base 4 may have any shape and/or configuration and be formed from any material(s), e.g., plastic, ceramic, stainless steel, polymers, rubber, etc. In another exemplary embodiment, the base 4 may be formed as a rack that may be free-standing or mountable on vertical surface. In this embodiment, the base 4 may include a mounting arrangement (e.g., screws, suction cups, etc.) for being mounted to a wall or other substantially vertical surface. This embodiment may be desirable if a user desires to keep the system 2 out of reach of children. In the exemplary embodiment, the housing 18 consists of a flat bottom piece 20 coupled to a dome-shaped cover 22. Feet (not shown) may be attached to an external surface of the bottom piece 20 to ensure that the base 4 does not slide relative to the horizontal surface. The bottom piece 20 may be coupled to the cover 22 through any conventionally known means, e.g., mechanical, chemical, electrical, magnetic, etc. The cover 22 may be rotatably mounted to the bottom piece 20 in another exemplary embodiment.

The receiving arrangement 6 for detachably receiving the handle 10 of the utensil 8 may be formed as a channel 24 created in the cover 22. The channel 24 may include a locking arrangement (e.g., friction fit, snap fit, magnetic, etc.) for retaining the handle 10 in the channel 24 or may rely on gravity. The channel 24 may further include electrical contacts 26 which mate with corresponding electrical contacts on the handle 10 for transferring power to the utensil 8, as will be explained below. As stated above, the base 4 may further include one or more connectors 28 for detachably receiving a corresponding one of the utensil attachments. Alternatively, each of the connectors 28 may be universal and receive any one of the utensil attachments. Each of the connectors 28 may statically maintain a corresponding one of the utensil attachments in a predefined position relative to the base 4. For example, as shown in FIG. 1, a knife connector holds the knife 14 substantially perpendicular relative to the bottom piece 20. Those of skill in the art will understand that the utensil attachments may be held in any positions relative to the base 4 and by any means including, but not limited to, snap fit, friction fit, magnetic, gravity, etc.

Referring back to FIG. 2, the electrical contacts 26 exposed in the channel 24 are coupled to a power supply arrangement 30 which is coupled to an external power source. In the exemplary embodiment, the power supply arrangement 30 is a power cord which plugs into an outlet to draw a line voltage. However, in other exemplary embodiments, the power supply arrangement 30 may draw power from an internal power supply such as, for example, a battery, a solar cell, etc., which allows the base 4 to be easily transported and used without being tethered to the external power source.

The base 4 may further include an activator (e.g., a button 32, a switch) and an indicator 34 (e.g., an LED), and a printed circuit board (PCB) 36 detecting a state of the button 32. In this embodiment, the user may activate the base 4 by pressing the button 32. When the base 4 is activated and the handle 10 is coupled thereto, a power source inside the handle 10 may be recharged. The indicator 34 may provide visual confirmation that the base 4 is activated and/or the handle 10 is being charged. In another exemplary embodiment, the base 4 may be activated upon connection to an external power supply.

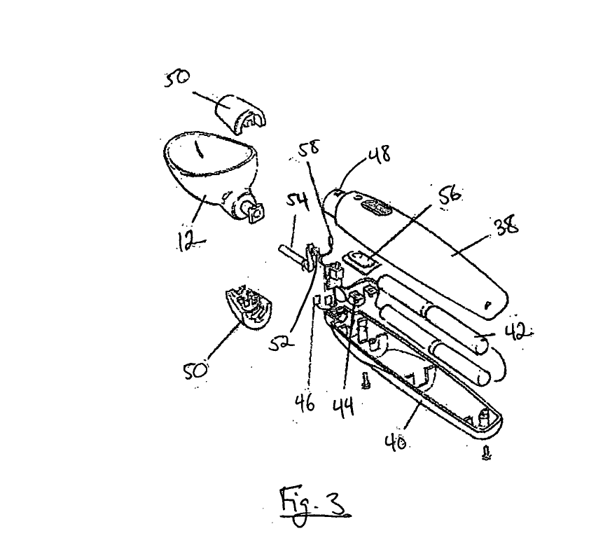

FIG. 3 shows an exemplary embodiment of the utensil 8 according to the present invention. The handle 10 may be formed as a handheld housing comprising first and second portions 38, 40 which are affixed together in any known manner (e.g., mechanically, chemically, electrically, etc.). In other exemplary embodiments, the handle 10 may be integrally formed or formed from more than two portions.

The handle 10 may further include a power source which, in the exemplary embodiment, includes at least one rechargeable battery 42. The power source may be at least partially situated within the handheld housing. As stated above, the batteries 42 may be charged by power from the power supply arrangement 30 in the base 4 when the handle 10 is coupled thereto. That is, when the handle 10 is inserted into the channel 24, first electrical contacts exposed from an external surface of the second portion 40 of the handle 10 may engage the electrical contacts 26 in the base 4 which are coupled to the power supply arrangement 30 to recharge the batteries 42 may be recharged. In other exemplary embodiments, the batteries 42 may be alkaline, or the handle 10 may include a power cord which interfaces with and is tethered to the power supply arrangement 30 in the base 4. Those of skill in the art will understand that the electrical contacts 26 need not be exposed to an external environment (e.g., to prevent corrosion, malfunction, etc.) so long as an electrical connection can be maintained with the electrical contacts on the handle 10.

Leads 44 electrically coupled the batteries 42 to second electrical contacts 46 which are exposed on a connector 48 formed at an end of the handle 10. In the exemplary embodiment, the connector 48 is a male connector shaped, sized and configured to detachably mate with a receiver 50 (e.g., a female connector) coupled to a housing of one of the utensil attachments, e.g., the scoop 12. In the exemplary embodiment shown in FIG. 3, the receiver 50 includes grooves which, when aligned with projections formed on an external surface of the connector 48, allow the receiver 50 to be coupled to the handle 10. Rotating the receiver 50 relative to the handle 10 creates a locking mechanical connection therebetween. As stated above, the utensil attachments may be detachably coupled to the handle 10 via, for example, a snap fit, an interlock fit, a frictional fit, etc.

The receiver 50 further includes third electrical contacts 52 which, when the receiver 50 is coupled to the handle 10, mate with the second electrical contacts 46, allowing power from the batteries 42 to be delivered to the utensil attachment. A heating element 54 is coupled to the third electrical contacts 52 to receive power therefrom via leads and is also coupled to the scoop 12. The heating element 54 may be at least partially situated within the housing of the utensil attachment. In use, the heating element 54 converts electrical energy into heat energy received from the batteries 42 to heat the scoop 12, as will be explained further below.

In the exemplary embodiment, the heating element 54 may be selectively activated by an activator (e.g., a button 56) disposed on the handle 8. The button 56 may be a conventional two-state button which, in a first state, completes a circuit and allows power to be delivered from the batteries 42 to the second electrical contacts 46 and to the heating element 54 when the receiver 50 is coupled to the handle 10. In a second state, the power supply is terminated. Those of skill in the art will understand that the activator may be, for example, a switch, a dial, a knob, etc. which uses an on/off mode or is adjustable to vary power delivery. For example, if the activator is a dial, rotating the dial in a first direction relative to the handle 10 may increase the power delivered to the second electrical contacts 46, while rotation in a second direction decreases the power delivery. An indicator (e.g., an LED 58) may be disposed on the handle 10 to indicate whether the power supply is enabled (first state) or terminated (second state). Those of skill in the art will understand that the indicator may be a visual, audible and/or tactile element which is indicative of whether the power supply is on/off and/or a rate of power delivery.

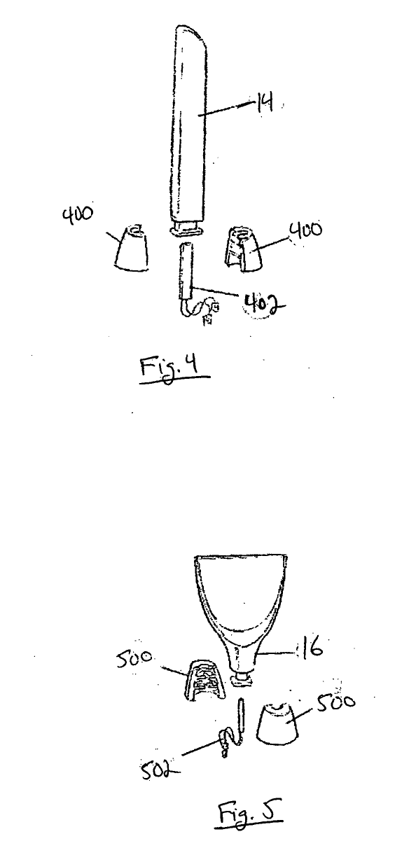

FIGS. 4 and 5 show embodiments of other exemplary utensil attachments which may be detachably coupled to the handle 10. In FIG. 4, the utensil attachment is the knife 14 which includes a receiver 400 (similar to the receiver 50) for mating with the connector 48 on the handle 10. Because the knife 14 attaches to the handle 10, only an operative portion of the knife 14 may be used as the utensil attachment. The receiver 400 includes a heating element 402 which is coupled to and, when activated, heats the knife 14. In FIG. 5, the utensil attachment is the server 16 which includes a receiver 500 (similar to the receiver 50) for mating with the connector 48 on the handle 10. The receiver 500 includes a heating element 502 which is coupled to and, when activated, heats the server 16.

When not in use, the handle 10 may be coupled to the base 4 so that the batteries 42 can recharge, and the utensil attachments may be coupled to the base 4 to prevent loss or damage. When a user removes ice cream, for example, from the freezer, he may attach the scoop 12 to the handle 10 in the manner described above. The user may then activate the heating element 54 in the scoop 12 by pressing the button 56 on the handle 10. When the scoop 12 has been sufficiently heated, the user may decouple the handle 10 from the base 4 and scoop the ice cream. Because the scoop 12 is heated, it will cut through the ice cream very easily. Preferably, there is no heat transfer from the heating element 54 to the handle 10.

Those of skill in the art will understand that the utensil attachments, as well as any other portion of the base 4, the handle 10, etc. may be formed from, for example, plastic, stainless steel, rubber, ceramic, etc. However, any portion of the utensil attachment and/or handle 10 that may come in to contact with the food item is preferably made from a USDA food-rated material.

In another exemplary embodiment of the present invention, selected portions of the utensil attachments may be heated while remaining portions are unheated. For example, the selected portions may be manufactured from a material that absorbs the heat energy from the heating element and increase in temperature, while the remaining portions may be made from materials which do not change temperature (e.g., because they absorb the heat energy or are not good heat transfer materials). In this manner, the user may touch the remaining portions of the utensil attachment at any time during use of the utensil 8. In another exemplary embodiment, a coating may be applied to achieve the same effect. For example, with regard to the knife 14, a blade may increase in temperature while a shaft remains at a pre-heating temperature and does not get hotter. This embodiment may be advantageous if the user decides to exchange utensil attachments while using the utensil 8.

In another exemplary embodiment, the indicator 58 (or a further indicator) on the handle 10 may be indicative of a temperature of the utensil attachment. A temperature sensor in the handle 10 may sense the temperature of the heating element in the utensil attachment. The indicator 58 may vary in, for example, color, brightness, etc. as a function of the temperature. The handle 10 may further include a display which displays the temperature sensed by the temperature sensor. Thus, the user may be aware of the temperature of the utensil attachment.

In another exemplary embodiment, the handle 8 may include an intelligence unit (e.g., processor, memory, sensors, etc.) which executes a predefined procedure based on the temperature of the utensil attachment. For example, if the user inadvertently leaves the utensil “on”, when the utensil attachment reaches a predefined temperature the intelligence unit may automatically terminate the power supply to the attachment.

The present invention has been described with reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A device, comprising:
a utensil attachment including a housing, a first connector and a heating element, the housing at least partially situating the heating element; and
a handle including a handheld housing, a second connector and a power source, the handheld housing at least partially situating the power source, the utensil attachment and the handle being detachably coupled using the first and second connectors,
wherein, when the first and second connectors are coupled together, the heating element draws power from the power source to increase a temperature of at least a portion of the housing of the utensil attachment.

2. The device according to claim 1, wherein the utensil attachment is an ice cream scoop.

3. The device according to claim 1, wherein the utensil attachment is an ice cream knife.

4. The device according to claim 1, wherein the utensil attachment is a server.

5. The device according to claim 1, wherein the utensil attachment is a spoon.

6. The device according to claim 1, wherein the utensil attachment is a fork.

7. The device according to claim 1, wherein the power source is a rechargeable battery.

8. The device according to claim 8, wherein the handle includes a power supply connector coupleable to an external power source to recharge the battery.

9. The device according to claim 9, wherein the power supply connector includes at least one electrical contact situated on an external surface of the handheld housing.

10. The device according to claim 1, wherein the handle includes an indicator indicating when the housing of the utensil attachment has reached a predetermined temperature.

11. The device according to claim 1, wherein the handle includes an activator which, when activated, allows the power from the power source to be transferred to the heating element.

12. The device according to claim 1, wherein the indicator is a light-emitting diode.

13. A system, comprising:
a handle including a handheld housing, a connector, a first power source and a first power supply connector, the handheld housing at least partially situating the power source, the connector detachably receiving a utensil attachment; and
a base including a receiving arrangement, a second power source and a second power supply connector, the receiving arrangement detachably receiving the handheld housing of the handle,
wherein, when the handheld housing is coupled to the receiving arrangement, the first power supply connector is coupled to the second power supply connector so that power is transferred from the second power source to the first power source.

14. The system according to claim 13, wherein the first power source is a rechargeable battery.

15. The system according to claim 13, wherein the second power source is one of a battery and a power cord coupled to a line voltage.

16. The system according to claim 13, wherein the utensil attachment is one of an ice cream scoop, an ice cream knife, a server, a spoon and a fork.

17. The system according to claim 13, wherein the base includes an indicator indicating when the power is being transferred from the second power source to the first power source.

18. The system according to claim 13, wherein the base includes an activator selectively activating the power transfer from the second power source to the first power source.

19. A utensil attachment, comprising:
a housing sized and shaped as an operative portion of a utensil;
a connector detachably coupling the housing to a handle; and
a heating element at least partially situated within the housing,
wherein, when the housing is coupled to the handle, the heating element draws power from a power source within the handle to increase a temperature of the housing.

20. The utensil attachment according to claim 19, wherein the operative portion is one of an ice cream scoop, an ice cream knife, a server, a spoon, a fork, a cookie cutter and a melon baler.
